(19) United States
(12) Patent Application Publication
(10) Pub. No.: US 2015/0019445 A1
(43) Pub. Date: Jan. 15, 2015

(54) PERSONALIZED MESSAGING PLATFORM

(71) Applicant: Gift Card Impressions, LLC, Kansas City, MO (US)

(72) Inventors: Brett R. Glass, Kansas Ctiy, MO (US); Nicole E. Glass, Kansas City, MO (US); Karl Joseph Geisler, Olathe, KS (US); Jill Leslie Rosen, Kansas City, MO (US)

(21) Appl. No.: 14/328,442

(22) Filed: Jul. 10, 2014

Related U.S. Application Data
(60) Provisional application No. 61/845,731, filed on Jul. 12, 2013.

(51) Int. Cl. G06Q 30/00; G06F 3/0481

(52) U.S. Cl. CPC G06Q 30/016; G06F 3/0481
USPC 705/304

(57) ABSTRACT

A personalized messaging system includes a personalized messaging application that is executed by a computing system to communicate with a computing device of a user to generate a personalized recipient message that may be transmitted to a customer. The application receives one or more instances of user-supplied content from the user computing device in which user-supplied content is associated with a product or service purchased by a customer in advance of delivery of the product or consumption of the service. From this information, the application generates a personalized recipient message using the user-supplied content, and transmits the personalized recipient message to the recipient.

### RELATED APPLICATIONS

This application takes priority to U.S. Patent Application Ser. No. 61/845,731, filed Jul. 12, 2013, and entitled “Personalized Customer Messaging Platform,” the contents of which are incorporated herein by reference in its entirety.

### FEDERALLY SPONSORED RESEARCH OR DEVELOPMENT

Not Applicable.

### COMPACT DISK APPENDIX

Not Applicable.

### FIELD OF INVENTION

The present invention generally relates to computer processing systems, and more particularly, to a personalized messaging platform and method of using the same.

### BACKGROUND

Expectations associated with products and/or services purchased by consumers as well as those provided as gifts to recipients are often not well managed. For example, retailers are often challenged with providing enhanced customer satisfaction for consumers who purchase their products or services. In many cases, customer satisfaction with purchased products or services may vary widely with respect to the actual utility provided by the product or service. For example, customer satisfaction associated with certain services, such as dining or hotel accommodations may depend in large part upon personal interaction of the retailer with the customer above and beyond the actual service (i.e., food or bedding) that is provided.

For this reason, retailers often seek to maintain a high level of customer satisfaction before and after purchase decisions made by their customers. Nevertheless, certain products or services may encounter a lapse in time between the purchase of the product and the delivery or consumption of the product or service. For example, the delivery of a product purchased via mail order often occurs several days after the product is purchased. Additionally, services, such as dining or hotel accommodations may be reserved several days in advance of the use of these services. It is with these issues in mind, among others, that various aspects of the present disclosure was developed.

### SUMMARY

Embodiments of a personalized messaging platform provide a solution for users seeking enhanced satisfaction of recipients of purchased products and/or services. The users may be retailers seeking customer satisfaction for their customers, or customers seeking enhanced excitement for recipients of their gifts. The solution is provided by personalized recipient messages including textual, photographic, audio, and/or video content that are delivered to a recipient before or after a product and/or service is received or used. The personalized recipient message includes pre-recorded as well as user-supplied content, such as textual, audio, photographic, and/or video content for increasing the appeal of the product or service purchased by a customer. The personalized recipient messages may be transmitted to recipients in any suitable manner, such as via e-mail messaging, short messaging services (SMS), multi-media services (MMS), or via a social media account of the customer.

According to one aspect, a personalized messaging system includes a personalized messaging application that is executed by a computing system to communicate with a computing device of a user to generate a personalized recipient message that may be transmitted to a customer. The application receives one or more instances of user-supplied content from the user computing device in which user-supplied content is associated with a product or service purchased by a customer in advance of delivery of the product or consumption of the service. From this information, the application generates a personalized recipient message using the user-supplied content, and transmits the personalized recipient message to the recipient.

According to another aspect, a personalized messaging method includes receiving one or more instances of user-supplied content from a user computing device in which the user-supplied content is associated with a product or service purchased by a customer in advance of delivery of the product or service to a recipient. The method further includes generating a personalized recipient message using the user-supplied content, and transmitting the personalized recipient message to a recipient computing device of the recipient.

According to yet another aspect, computer executed instructions are configured to receive one or more instances of user-supplied content from a user computing device in which the user-supplied content is associated with a product or service purchased by a customer in advance of delivery of the product or service to a recipient. The instructions are further executed to generate a personalized recipient message using the user-supplied content, and transmit the personalized recipient message to a recipient computing device of the recipient.

### BRIEF DESCRIPTION OF THE DRAWINGS

FIG. 1A is a block diagram of an example computing system that includes a personalized messaging platform according to an aspect of the personalized messaging platform.

FIG. 1B is a block diagram of an example computing device according to one aspect of the personalized messaging platform.

FIG. 1C is a block diagram of an example data source according to an aspect of the personalized messaging platform.

FIG. 2 is a block diagram of an example personalized messaging server that includes a personalized messaging application according to an aspect of the personalized messaging platform.

FIG. 3 is an example flowchart depicting a process for creating and transmitting a personalized recipient message according to an aspect of the personalized messaging platform.

FIG. 4 illustrates an example sign in screen according to an aspect of the personalized messaging platform.

FIG. 5 illustrates an example account registration screen according to an aspect of the personalized messaging platform.

FIG. 6 illustrates an example message management screen according to an aspect of the personalized messaging platform.

FIG. 7 illustrates an example message template selection screen according to an aspect of the personalized messaging platform.

FIG. 8 illustrates an example template customization screen according to an aspect of the personalized messaging platform.

FIG. 9 illustrates an example preferences screen according to an aspect of the personalized messaging platform.

FIG. 10 illustrates an example recipient information entry screen according to an aspect of the personalized messaging platform.

FIG. 11 illustrates an example recipient characteristic information entry screen according to an aspect of the personalized messaging platform.

### DETAILED DESCRIPTION

Customer satisfaction has been generally accepted by retailers to be an important aspect of business success. Nevertheless, customer satisfaction may be difficult to control using certain business models in which products or services may be purchased and/or reserved several days in advance of the delivery or consumption of the product or service, such as a retailer providing mail order delivery in which the product is delivered several days following purchase of the product, or reservations for a service to be consumed by the customer at a later date. Embodiments of the present disclosure may provide a solution to this problem using a personalized messaging server that provides retailers of products and/or services with a personalized messaging platform for generating and transmitting personalized messages to their customers before and/or after their customer takes delivery of the product or at the time of consumption of a service provided by the retailer.

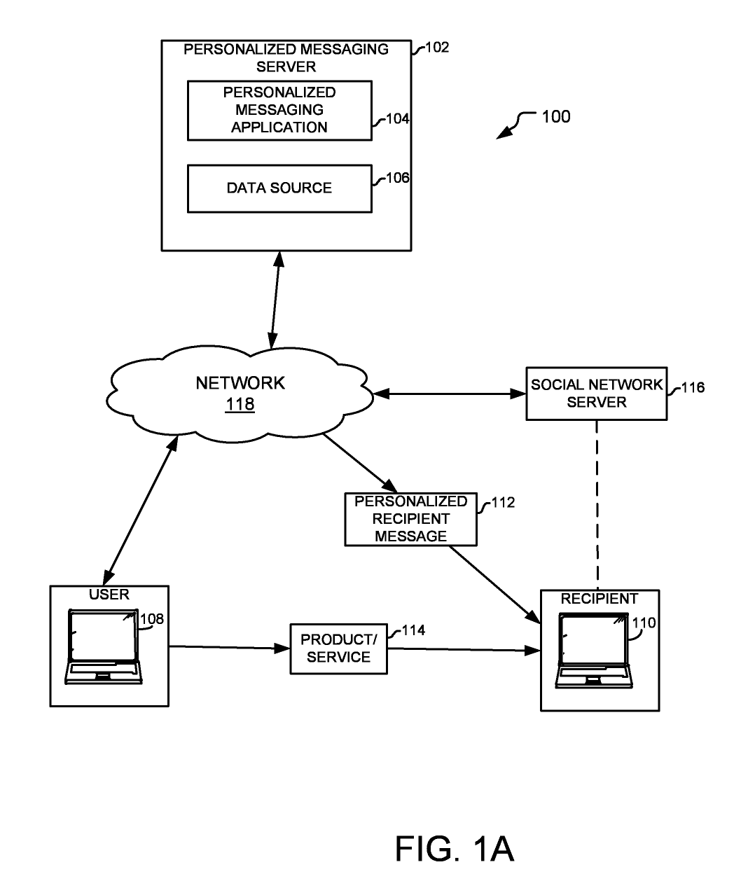

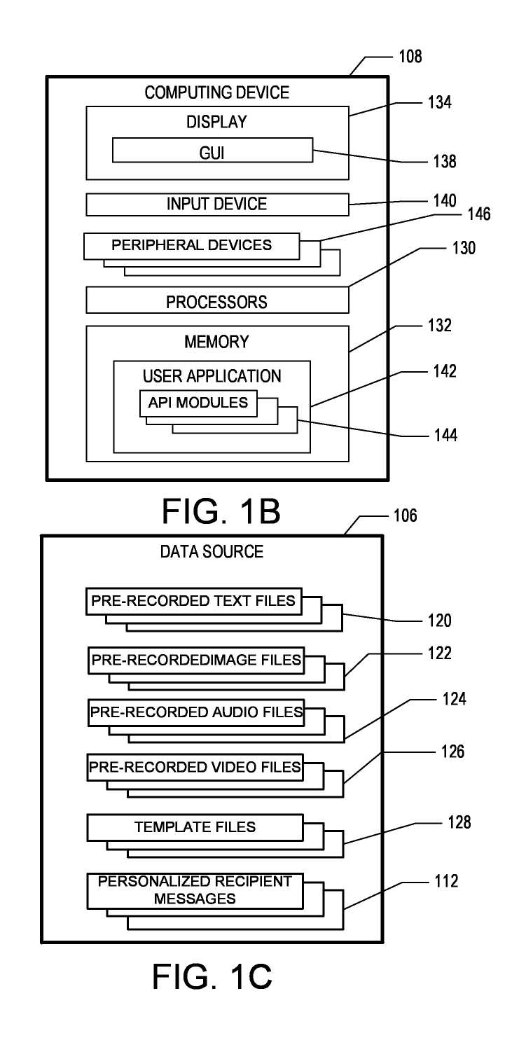

FIGS. 1A through 1C depict an example personalized messaging platform 100 according to aspects of the disclosure. The system 100 includes a personalized messaging server 102 that includes a personalized messaging application 104 and a data source 106. As will be described in detail below, the personalized messaging application 104 receives personalized content from a computing device 108 of a user, generates a personalized recipient message 112 using the user-supplied content, and transmits the personalized recipient message to a computing device 110 of a recipient, in which the message is associated with a product and/or service provided to the recipient.

The personalized recipient message 112 generally includes user-supplied content, such as one or a combination of textual information, photographic information, audio content, and/or video content for communicating information, such as a desired sentiment, theme, or occasion, from the user to the customer. Typically, the personalized recipient message is approximately 30 to 90 seconds in length, although other embodiments contemplate a personalized recipient message having any suitable length, such as shorter than 30 seconds or longer than 90 seconds. The personalized recipient message 112 includes user-supplied content provided by the user and may include specific information associated with the recipient, such as the recipient's name, interests, age, gender, location, and/or certain words or phrases describing the recipient. In one embodiment, the personalized recipient message 112 includes content associated with a product and/or service purchased by the user for the recipient.

In one embodiment, the product/service is a gift purchased by the user to be given to the recipient. In another embodiment, the user is a retailer having numerous customers (e.g., clients) that may each be sent a personalized recipient message. For example, the retailer may be a hotel in which patrons (e.g., customers) may reserve rooms (e.g., a service) days in advance of consuming the service. Embodiments of the personalized messaging platform provides a mechanism for managing and sending personalized recipient messages to each customer in a manner that enhances communication between the hotel and its customers.

In one embodiment, the personalized recipient message 112 may be a flat file, such as a CSV file, a text document, a spreadsheet document (e.g., XLS) file, and the like. In another embodiment, the personalized recipient message 112 may have a structured format having multiple types of content overlaid on a template. For example, the personalized recipient message 112 may include a photograph or video segment on which a text message is overlaid.

The product/service 114 may be any product and/or service provided by the user. In one embodiment, the product/service 114 is purchased and/or reserved by the user at a separate time from which the product/service 114 is delivered or consumed, respectively, by the recipient. Such example products include those, which after initial purchase, are to be delivered via conventional mail delivery services, such as the UNITED PARCEL SERVICE™. Other example services include services provided by retailers, such as restaurants, medical practitioners, hotels, or entertainment venues such as ballets, concerts, sporting matches, and the like. For certain services, such as dining services or hotel accommodations, reservations may be made at a time prior to consumption (i.e., usage) of the service and payment rendered at the time of consumption. For other services, such as entertainment venues, tickets may be purchased in advance of consumption of the purchased entertainment venue. In either case described above, the delivery and/or consumption of the product or service occurs at a time after which the product or service is purchased and/or reserved.

Embodiments of the present disclosure provide an advantage in that consumer satisfaction of those consumers who purchase and/or reserve products and/or services in advance of their delivery and/or consumption may be enhanced by providing an organized technique for providing interaction with the consumer using personalized recipient messages 112. These personalized recipient messages 112 are sent to the recipients shortly before delivery of the product or service for increased anticipation. Alternatively, the personalized recipient messages 112 are sent to the recipient shortly after delivery for enhanced perceived follow through with the recipient by the user.

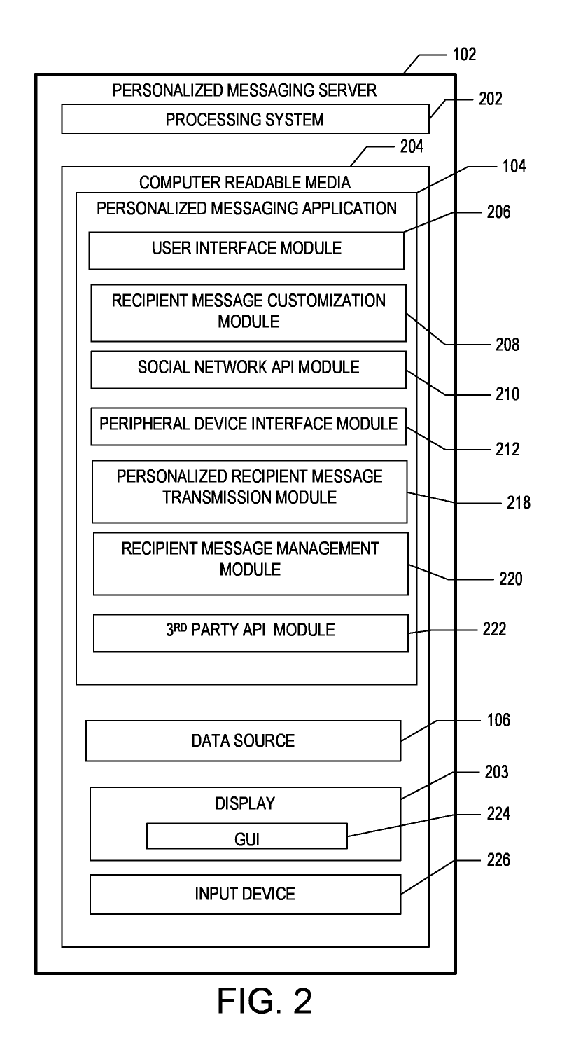

The server 102 includes a processing system 202 (FIG. 2) that executes the personalized messaging application 104 stored in computer readable media 204 (i.e., volatile and/or non-volatile memory) using the data source 106. Examples of a server 102 include one or more servers, personal computers, mobile computers and/or other mobile devices, and other computing devices. The server 102 may communicate via wireless and/or wireline communications.

The server 102 communicates with the computing device 108 to receive user-supplied content from the user for generating the personalized recipient message 112 that is subsequently transmitted to a computing device 110 of the recipient. For example, the user-supplied content may include textual, audio, photographic, and/or video content including information associated with a sentiment that the user wishes to convey to the recipient. The server 102 also communicates with a social network server 116 to obtain information about the recipient for suggesting additional content to be included with the personalized recipient message 112. The social network server 116 and computing device 110 has one or more processors and executable instructions stored in volatile and/or non-volatile memory for performing the actions and/or steps described herein.

The data source 106 stores information that is used by the user to generate the personalized recipient message 112. In the particular embodiment shown, the data source 106 stores one or more pre-recorded text files 120, one or more pre-recorded image files 122, one or more pre-recorded audio files 124, one or more pre-recorded video files 126, multiple template files 128, and multiple personalized recipient messages 112 created by one or more users. In other embodiments, the data source 106 stores any suitable type of information for generating personalized recipient messages 112 that are sent to their recipients. Although the data source 106 is shown as being located on, at, or within the local server 102, it is contemplated that the data source 106 can be located remotely from the local server 102 in other aspects of the system 100, such as on, at, or within a database of a data management system or a database of another computing device or system having at least one processor and volatile and/or non-volatile memory.

The communication network 118 can be the Internet, an intranet, or another wired and/or wireless communication network, such as a public switched telephone network (PSTN) or cellular network. In one aspect, one or more of the server 102 and the computing device 108 communicate with one another using any suitable protocol or messaging scheme. For example, the server 102 and computing device 108 communicates using a Hypertext Transfer Protocol (HTTP), extensible markup language (XML), extensible hypertext markup language (XHTML), or a Wireless Application Protocol (WAP) protocol. Other examples of communication protocols exist. Although the example of FIG. 1A shows the server 102 communicating with the computing device 108 through a network, other embodiments contemplate the server 102 communicating directly with the computing device 108 without the use of a separate and a distinct network. Additionally, other embodiments contemplate that the modules employed by the server 102 and the computing device 108 are integrated in one computing system. Further, the social network server 116 communicates with the personalized messaging server 102 via the network 118.

The personalized messaging application 104 provides a mechanism for generating a personalized recipient message 112 including personalized content by uploading one or more photographs, customized text messages such as a greeting, adding pre-recorded songs, sound (e.g., voice) messages, video content and combining this information to form the personalized message. In some cases, the user-supplied content may be combined with a recipient message template 128. In one embodiment, the user-supplied content (e.g., text, sound, images, and/or video) may be generated by a peripheral device 146 of the computing device 108. For example, the user-supplied content may be received from a peripheral device 146, such as a web camera (i.e., webcam) coupled to a workstation. As another example, the user-supplied content may be received from another peripheral device 146 such as a camera and/or microphone configured on a cellular telephone.

The resulting personalized recipient message 112 may be for example, an audio message including audio content, an image including one or more photographs and text content overlaid on the photographs, or a video message including a combination of photographs, audio, and/or video segments that may be overlaid with text content. In one embodiment, the user may select one recipient message template from among multiple recipient message templates 128 each having one or more content structures in which a corresponding one or more instances of user-supplied content is included by the user. In other embodiments, the personalized recipient message 112 is generated entirely with user-supplied content. The user accesses the system 100 via the computing device 108 hosted by the personalized messaging server 102 using an HTML link or other suitable entry point, such as through application software (i.e., a mobile app) executed on a portable computing device, such as a wireless communication device.

FIG. 1B depicts an example embodiment of a computing device 108 according to one aspect of the personalized messaging platform 100. The computing device 108 is a computing or processing device that includes one or more processors 130 and memory 132. For example, the computing device 108 can be a personal computer, such as a laptop or notebook computer, a workstation, or other processing device such as a personal digital assistant or a tablet computer. The computing device 108 includes a display 134, such as a computer monitor, for displaying data and/or a graphical user interface 138. The computing device 108 also includes an input device 140, such as a keyboard or a pointing device (e.g., a mouse, trackball, pen, or touch screen) to enter data into or interact with the graphical user interface 138. In one embodiment, the display 134 comprises a touch-screen device in which input is provided via contact by the user with the touch-screen device. The computing device 108 receives data and/or communications from, and/or transmit data and/or communications to, the server 102 via the communication network 118.

The computing device 108 includes a user application 142 stored in the memory 132 and executed on the processors 130 to generate the graphical user interface (GUI) 138 to the display 134. The graphical user interface 138 enables the computing device 108 of the user to interact with one or more data entry forms received from the server 102 to enter order detail data and submit customized content to the application 104. In one embodiment, the user application 142 includes a web browser that displays interactive web pages, applets, or other suitable user interface mechanisms including one or more selectable fields, editing screens, and the like for selecting content and/or modifying pre-recorded content by the user. In another embodiment, the GUI application 142 includes application software (i.e., a mobile app) that is executed on the computing device 108, which is, for example, a wireless communication device for providing one or more selectable fields, edit screens, and the like for selecting content and/or modifying pre-recorded content by the user.

According to an aspect of the present disclosure, the user application 142 also includes one or more application program interface (API) modules 144 for communicating with one or more peripheral devices 146 configured in the computing device 108 or for exposing information used by the personalized messaging application. Certain API modules 144 may be used to receive user-supplied content from the user. For example, one API module 144 interfaces with a keyboard of the computing device 108 owned by the user for receiving alpha-numeric text information that may be included in the personalized recipient message, while another API module 144 interfaces with a microphone configured on the computing device 108 for receiving audio content from the user for inclusion in the personalized recipient message. Additionally, certain API modules 144 may be implemented for providing information to the personalized messaging server 102 for generating the personalized recipient messages. For example, the user may store, on the computing device 108, an ongoing list of recipients along with specific products and/or services to be delivered and the delivery date of these products and/or services in which this information is exposed through one or more API modules 144. The personalized messaging application 104 may request and obtain this information on a periodic basis to automatically generate personalized recipient messages using these API modules 144.

FIG. 2 is a block diagram depicting an example personalized messaging application 104 executed on the personalized messaging server 102. According to one aspect, the personalized messaging server 102 includes a processing system 202 that includes one or more processors or other processing devices. A processor is hardware. The processing system 202 executes the personalized messaging application 104 to generate the GUI 148 on the computing device 108 for receiving customized information from the user and generating a personalized recipient message to be sent to a recipient. According to another aspect, the personalized messaging server 102 also includes a display 203, such as a computer monitor, for displaying data and/or a graphical user interface 224. The personalized messaging server 202 also includes an input device 226, such as a keyboard or a pointing device (e.g., a mouse, trackball, pen, or touch screen) to enter data into or interact with the graphical user interface 224.

According to one aspect, the personalized messaging server 102 includes a computer readable medium 204 configured with the personalized messaging application 104. The personalized messaging application 104 includes instructions or modules that are executable by the processing system 202 to generate a customized recipient message to be sent to a recipient.

The computer readable medium 204 includes volatile media, nonvolatile media, removable media, non-removable media, and/or another available medium that can be accessed by the personalized messaging server 102. By way of example and not limitation, computer readable medium 204 comprises computer storage media and communication media. Computer storage media includes non-transient storage memory, volatile media, nonvolatile media, removable media, and/or non-removable media implemented in a method or technology for storage of information, such as computer readable instructions, data structures, program modules, or other data. Communication media embodies computer readable instructions, data structures, program modules, or other data and include an information delivery media or system.

A user interface module 206 facilitates the receipt of data and/or other communications from the computing device 108 of the user. In one example, the user interface module 206 communicates with the computing device 108 using a web browser executed on the computing device 108 to provide one or more selectable fields, editing screens, and the like for receiving content and/or modifying pre-recorded or user-supplied content from the user. In another example, the user interface module 206 communicates with the computing device 108 using application software (i.e., a mobile app or application software (e.g., based on the HTML5 markup language) rendered on a web browser) executed on a computing device 108, such as a wireless communication device or tablet computer, to provide one or more selectable fields, editing screens, and the like for receiving content and/or modifying content by the user. In yet another example, the user interface module 206 communicates with one or more peripheral devices 156 of the computing device 108 to receive user-supplied content to be included in the personalized recipient message.

A recipient message customization module 208 receives personalized content from the computing system 108, and provides for the customization of content, such as content received from the user interface module 206. For example, the recipient message customization module 208 receives personalized content generated by the user and processes the received user-supplied content to generate customized content to be included in the personalized recipient message 112. For another example, the recipient message customization module 208 receives user selection of a recipient message template including a particular design associated with a particular service provided by or purchased by the user. In one particular case, the user comprising a retailer selects a design that advantageously promotes the type of product or service sold by that retailer. For example, a user of a restaurant may select a template design including pre-recorded content showing how good certain foods may taste. In another particular case, the product/service is a gift purchased by the user for the recipient in which a design is selected for enhancing the gifting experience for the recipient.

The user-supplied content to be included in the selected template file also includes content stored in the data source 106, such as pre-recorded text information from pre-recorded text files 120, pre-recorded image information from pre-recorded image files 122, pre-recorded audio information from pre-recorded audio files 124, and/or pre-recorded video information from pre-recorded video files 126 that is further manipulated by the user via the GUI 138. In a particular embodiment, the user-supplied content includes pre-recorded content including a song or a portion of a pre-recorded song that is copyrighted and licensed by the owner of the copyrighted song. The recipient message customization module 208 modifies existing content, such as pre-recorded content or other previously received content, based upon input received from the computing system 108. An example of modifying existing content includes modifying a received photograph using one or more photograph editing features that provides for cropping, color hue adjustment, brightness adjustment, sizing, and/or other features associated with manipulation of digital imagery.

In one embodiment, the personalized recipient message is a template-based FLASH™ file or an HTML5-based file having predetermined content structures (e.g., placement areas) that are marked and tracked within the file. Uploaded content (e.g. text, audio, image, or video segments) are mapped within the content structures in the file using a compositing mechanism, such as a video compositor. Once content is uploaded and mapped to the content structures, the application 104 displays a preview of the personalized recipient message through a suitable player. The application 104 then saves the file as a personalized recipient message (e.g., Flash video file, MP4, or HTML5-based file) that is set for streaming from a video management system, such as the user recipient message management module 220 via a suitable content delivery network (e.g. Rackspace or Akamai CDN). In some embodiments, the user recipient message management module 220 includes the content delivery network.

In one embodiment, the personalized recipient message may be composited using any mechanism, which may include a system specific custom compositing engine based on Open Source Media Framework Template Flash video files provided by ADOBE™ or a video compositor that renders and displays HTML5-based code. The video may be viewed using any mechanism, such as a system specific, custom video player based on the Open Source Media Framework.

A social network API module 210 provides an interface to one or more social network web sites to provide additional information about the recipient for customizing the personalized recipient message 112. For example, the social network API module 210 accesses the API of a FACEBOOK™ social network to identify certain characteristics that the recipient deems to be important about the products/services sold by the user. The social network API module 210 displays this information on the computing device 108 of the user so that the user may include information in the personalized recipient message 112 that is deemed to be important to the recipient.

A peripheral device interface module 212 provides an interface to one or more peripheral devices of the computing device 108 of the user, such as a global positioning system (GPS) device, a camera, a microphone, and other device configured on the computing system 108. For example, the peripheral interface module 212 location information associated with a GPS device to obtain demographic information about the region around the user for enhanced selection of pertinent content to be included in the personalized recipient message 112. For another example, the peripheral device interface module 212 receives audio, still imagery, and/or video content using the microphone and/or camera configured on the computing device 108.

A personalized recipient message transmission module 218 facilitates the transmission of the personalized recipient message 112 to the recipient. In one example, the personalized recipient message 112 is generated in digital form and transmitted to the recipient via any suitable communication mechanism, such as via an e-mail message, a short message service (SMS) message, or through a social media portal, such as FACEBOOK™, TWITTER™, PINTEREST™, INSTAGRAM™, YOUTUBE™, and GOOGLE™. The personalized recipient message transmission module 218 manages a transmission time at which the personalized recipient message 112 is transmitted to the recipient. That is, the personalized recipient message transmission module 218 receives, from the user, information associated with a time when the personalized recipient message 112 is to be transmitted to the computing device 108 of the recipient. The time may be prior to or after delivery of the product and/or use of the service by the recipient. For example, a restaurant user may generate a personalized recipient message 112 for a recipient who has reserved a dining engagement at a future date. The personalized recipient message transmission module 218 receives information from the user associated with a time shortly before the dining engagement such that the personalized recipient message 112 is transmitted to the recipient shortly before the scheduled dining engagement.

A user recipient message management module 220 stores and manages multiple personalized messages for use by multiple users. The users may each generate several personalized recipient messages 112 for multiple types of recipients and store each of these personalized recipient messages 112 in the personalized recipient messages 112 in the data source 106. Thereafter, upon purchase or reservation of a product or service by a recipient, the user selects one personalized recipient message 112 from among multiple personalized recipient messages for sending to that recipient. For example, a restaurant user generates three personalized recipient messages, one for recipients who typically dine at the restaurant during lunch, one for recipients who typically dine at the restaurant during evening time, and one for recipients who typically schedule large parties at the restaurant. Thereafter, when a recipient makes a reservation, the restaurant user categorizes the recipient according to information gathered using one or more social media accounts associated with the recipient along with the user's personal knowledge of the recipient. Using this categorized information, the user selects an appropriate personalized recipient message 112 according to the categorization of the recipient.

The user recipient message management module 220 uses a third party platform for storage and delivery of recipient messages 112. In one embodiment, the user recipient message management module 220 uses a cloud-based content delivery network (CDN), such as RACKSPACE™ or AMAZON™ AWS, for storing the uploaded user images and a video server for storage and streaming of the personalized recipient messages. Additionally, via SWF to MP4 Conversion Tools, the user recipient message management module 220 encodes the personalized recipient messages into an MP4 format for optional playback on mobile devices. In certain embodiments, the user recipient message management module 220 encodes the personalized recipient message in HTML5 format to play audio and video within webpages and, for example, to construct and play videos provided by the system.

A third party API module 222 exposes the personalized messaging platform for use by third party systems, such as a website of a user or a portal that manages reservations for services, such as hotel and/or travel services. For example, a restaurant chain may incorporate the services provided by the personalized messaging platform using a link implemented on their website. Thus, when reservations are made with a recipient, the user may generate a personalized recipient message by accessing the link on their native website.

It should be appreciated that the modules described herein are provided only as an example of a computing device that executes the personalized messaging application 104 according to the teachings of the present invention, and that other computing systems may have the same modules, different modules, additional modules, or fewer modules than those described herein. For example, one or more modules as described in FIG. 2 is combined into a single module. As another example, certain modules described herein are encoded on, and executed on other computing systems, such as the computing device 108 used by the user.

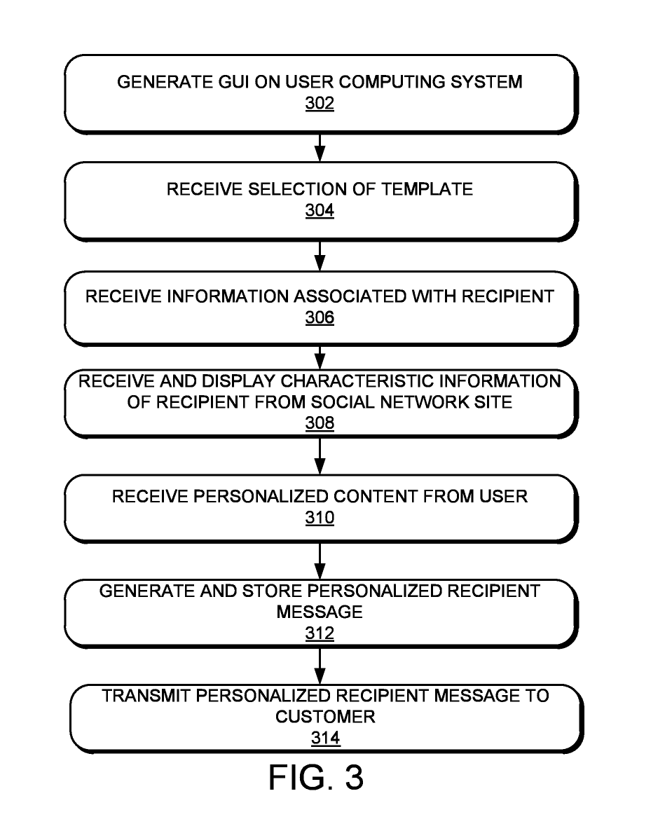

FIG. 3 illustrates an example process that is performed by the personalized messaging application 104 according to the teachings of the present disclosure.

In step 302, the personalized messaging application 104 receives a request from a computing device 108 of a user and generates a GUI on the computing system for receiving personalized content from the user. In one embodiment, the GUI is generated as a web page that is rendered by a web browser executed on the computing device 108 through a network, such as the Internet. In another embodiment, the GUI is generated by application software (i.e., a mobile app) designed to be executed on a computing device 108 embodied as a wireless communication device, a tablet computer, or other similar type of portable computing device.

The user accesses the system 100 via the interface of the computing device 108 hosted by the personalized messaging server 102. A user may arrive at the system interface via an HTML link or other suitable entry point, such as through a mobile app executed on a portable computing device. The user typically initiates the online personalized messaging platform by requesting a URL of the server 102 through a browser or by launching the mobile app on a portable computing device, such as a wireless communication device or portable tablet computer from which the GUI is generated on the computing device 108.

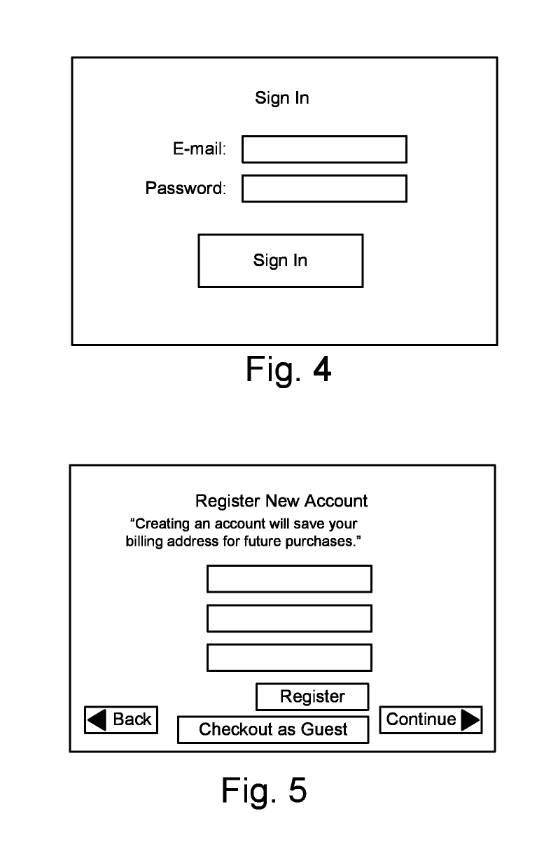

For example, the application 104 generates a sign-in screen (FIG. 4) on the user computing device 108. In the event that the user has not yet established an account, the application 104 generates a registration screen (FIG. 5) on the user computing device for registration of the user. In other embodiments, information associated with the user without the sign-in screen, and registration screen as shown in FIGS. 4 and 5, respectively if registration of the user is not needed or desired.

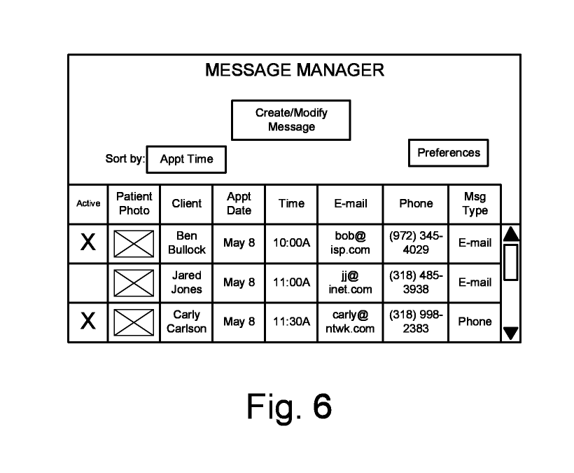

As another example, the application 104 may generate a message management screen (FIG. 6) for management of recipient messages to multiple customers, such as may be used by retailers that typically have large numbers of customers or clients. The particular message management screen shown herein is adapted for use by veterinarians; nevertheless, it should be understood that the message management screen may be adapted for use by any retailer having multiple customers.

In general, the message management screen maintains a table in which each row corresponds to a customer of the retailer and the columns of the table include various aspects of each customer, such as the customer's name, a scheduled appointment date and time, and contact information including e-mail addresses and telephone numbers. The message management screen also includes a ‘Msg Type’ column that is editable by the user (e.g., retailer) for indicating the communication medium (e.g., e-mail or phone) used for transmitting the recipient message to the customer. Additionally, the message management screen includes an ‘Active’ column that is editable by the retailer for indicating whether or not the customer is to receive a recipient message. Although the above described aspects of each column are shown and described herein, it should be understood that other aspects may be included in the message management screen without departing from the spirit and scope of the present disclosure.

The message management screen also includes several buttons for facilitating management of recipient messaging for multiple recipients. For example, the messaging management screen includes a sorting button that allows the user to sort how the customers are organized on the table. For example, the customers may be sorted according to those having the nearest scheduled appointment, according to the customer's name, according to the communication medium used to convey the recipient message, and the like.

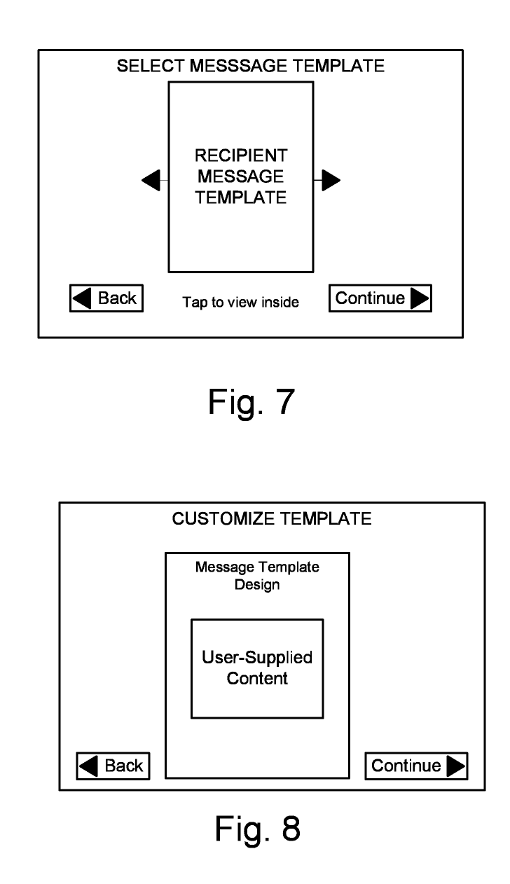

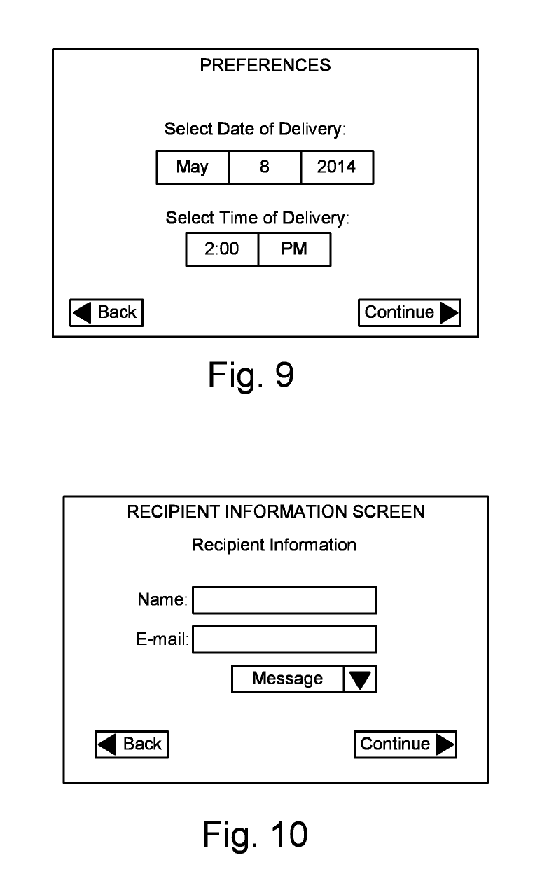

The message management screen also includes a ‘Create/Modify Message’ button that, when selected by the user, causes the application 104 to interactively generate a new recipient message or modify an existing recipient message, such as by generating a message template selection screen (FIG. 7) and a recipient message customization screen (FIG. 8) as will be described in detail herein below. Additionally, the message management screen includes a ‘Preferences’ button that allows the user to adjust or modify one or more aspects of how recipient messages are delivered to their respective recipients, such as by generating a preferences entry screen (FIG. 9) for user entry of delivery time for each recipient message sent.

In step 304, the personalized messaging application 104 optionally receives selection of one template from among multiple templates stored in the server. For example, the application 104 may generate a template selection screen as shown in FIG. 7 for receiving selection of a template from the user. Each template includes one or more content structures for inclusion of a corresponding one or more instances of user-supplied content from the user. For example, an initial segment of one template includes a content structure adapted to accept a user-supplied photograph and overlay textual content from the user that, when the template is played, the photograph and overlaid textual content is initially displayed for providing environment-based content for other content information included in the template. As another example, another content structure of the template includes a text entry field for entering time and date information to remind the recipient of the upcoming reserved date. As yet another example, another content structure of the template includes a video segment portion in which displays a personalized video segment received from the computing device 108 of the user.

In step 306, the personalized messaging application 104 receives information associated with the recipient who has recently purchased and/or reserved a product or service from the user. For example, the personalized messaging application 104 generates a recipient information screen (FIG. 10) to receive one or more identifying elements of the recipient, such as name, address, e-mail address, and the like from the user.

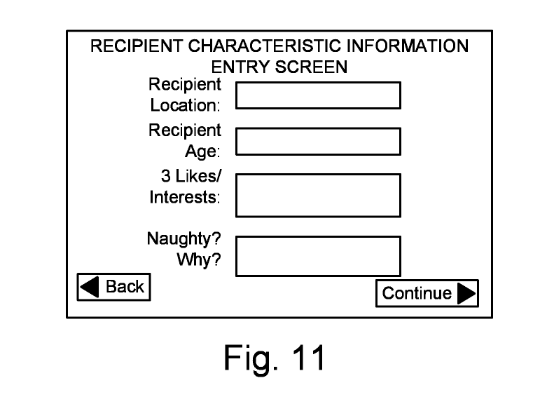

In step 308, the personalized messaging application 104 obtains characteristic information associated with the recipient from a social network site, such as FACEBOOK™. For example, the application 104 generates a recipient characteristics information screen (FIG. 11) to receive characteristic information about the recipient. The personalized messaging application 104 uses this information to provide targeted suggestions to the user for designing the personalized recipient message to be sent to the recipient.

In step 310, the personalized messaging application 104 receives personalized content from the computing device 108 of the user. The personalized content may include previously stored content stored by the server 102, or may include content provided by the user. For example, the personalized messaging application 104 generate the recipient message customization screen (FIG. 8) for including textual content, pre-recorded audio content, pre-recorded photographic content, or pre-recorded video content stored in the server into the personalized recipient message template.

As another example, the personalized messaging application 104 accesses an API of a peripheral device of the computing device 108 to directly receive content from a the peripheral device and include the content in a content structure portion of the template. From a user perspective, the user uploads a photo or other image via an interface such as a Flash based player interface. The user may upload image files in any system-supported format, such as a JPG, TIFF, PNG, or BMP format. The user may also select a file from a social media network, which the system facilitates through the social network API module 210. The application 104 receives the uploaded content and includes the image in a content structure portion of the template. The application also enables modification of the uploaded content by the user. For example, the application 104 enables drag and drop mouse operations as well as other controls for moving the content left, right, up, down, zooming in/out, and rotating the content.

In step 312, the personalized messaging application 104 generates a personalized recipient message 112 in accordance with information provided by the user of the computing device in steps 302 through 310. The personalized messaging application 104 also receives schedule information associated with a time of transmission of the personalized recipient message 112 to the recipient. The personalized messaging application 104 stores the generated message 112 for delivery to the recipient at the specified time. In one embodiment, the application 104 stores and manages multiple personalized messages for use by multiple users. Each user can generate several personalized recipient messages 112 for multiple types of recipients and store each of these personalized recipient messages 112 in the personalized recipient messages 112 in the data source 106. Thereafter, upon purchase or reservation of a product or service by a recipient, the user selects one personalized recipient message 112 from among multiple personalized recipient messages for sending to that recipient.

In step 314, the personalized messaging application 104 transmits the personalized recipient message to the recipient. In one embodiment, the personalized messaging application 104 transmits the personalized recipient message at the scheduled time associated with the generated personalized recipient message. In another embodiment, the personalized messaging application 104 manages multiple personalized recipient messages generated by multiple users and transmits each of the personalized recipient messages at an appointed time as specified by schedule information associated with the personalized recipient messages.

In yet another embodiment, the personalized messaging application 104 transmits a hypertext link or a quick response (QR) code to the computing device of the recipient such that, when selected by the recipient, the personalized recipient message stored in the data source may be accessed and transmitted to the recipient. For example, the application 104 transmits a hypertext link or QR code via an e-mail message or via physical media on which the QR code is printed. Upon receipt, the recipient accesses the personalized recipient message through the link provided by the hypertext link or QR code.

The process described above is performed repeatedly for additional personalized recipient messages to be sent to one or more recipients. When use of the personalized messaging application 104 is no longer needed or desired, the process ends.

It should be appreciated that the steps described herein is provided only as an example of a process that is performed by the personalized messaging application 104 according to the teachings of the present invention, and that the personalized messaging application 104 may perform fewer, more, or different types of steps than those described herein. For example, the personalized messaging application 104 performs multiple steps described above as a single step. As another example, certain steps described herein is performed by other components of the personalized messaging platform 100, such as by the computing device 108 used by the user.

Those skilled in the art will appreciate that variations from the specific embodiments disclosed above are contemplated by the invention. The invention should not be restricted to the above embodiments, but should be measured by the following claims.

What is claimed is:

1. A personalized messaging system comprising:
an application stored in at least one memory and executable by at least one processor and in communication with a user computing device of a user, the application executable by the at least one processor to:
receive one or more instances of the user-supplied content from the user computing device, the user-supplied content associated with a product or service purchased by a customer;
generate a personalized recipient message using the user-supplied content; and
transmit the personalized recipient message to a recipient computing device of a recipient, in advance of delivery of the product or service to the recipient.

2. The system of claim 1, wherein the customer comprises the user, and wherein the product or service comprises a gift purchased by the customer to the recipient.

3. The system of claim 1, wherein the user comprises a retailer that provides the product or service, and wherein the customer comprises the recipient.

4. The system of claim 3, wherein the retailer comprises at least one of a hotel owner, restaurant owner, or an entertainment provider, and wherein the one template includes previously stored content associated with the product or service sold by the retailer.

5. The system of claim 1, wherein the application:
displays a plurality of message templates on a graphical user interface (GUI) of the user computing device, each template including one or more content structures for playing a corresponding one or more instances of user-supplied content;
receives a selection of one template from the GUI; and
generates the personalized recipient message using the selected template and the user-supplied content.

6. The system of claim 1, wherein the application receives time information associated with a time of delivery of the personalized recipient message from the user, and transmits the personalized recipient message at the scheduled time.

7. The system of claim 1, wherein the GUI of the user computing device executes at least one of a web browser and a mobile app.

8. The system of claim 1, wherein the application transmits a hypertext link to the personalized recipient message to the recipient computing device, and the personalized recipient message stored in the memory, and wherein the recipient computing device is configured to access the personalized recipient message via the hypertext link.

9. The system of claim 1, wherein the application transmits a quick response (QR) code to the personalized recipient message to the customer computing device, and wherein the QR code includes a link to the personalized recipient message stored in the memory.

10. The system of claim 1, wherein the application obtains characteristic information about the customer from a social network site, and displays suggested content based upon the obtained characteristic information.

11. The system of claim 1, wherein the personalized recipient message is comprised entirely of user-supplied content.

12. A personalized messaging method comprising:
receiving, using at least one processor that executes an application stored in a memory, one or more instances of the user-supplied content from the user computing device, the user-supplied content associated with a product or service purchased by a customer;
generating, using the application, a personalized recipient message using the user-supplied content; and
transmitting, using the application, the personalized recipient message to a recipient computing device of a recipient in advance of delivery of the product or service to the recipient.

13. The method of claim 12, wherein the customer comprises the user, and wherein the product or service comprises a gift purchased by the customer to the recipient.

14. The method of claim 12, wherein the user comprises a retailer that provides the product or service, and wherein the customer comprises the recipient.

15. The method of claim 12, further comprising:
displaying a plurality of message templates on a graphical user interface (GUI) of the user computing device, each template including one or more content structures for playing a corresponding one or more instances of user-supplied content;
receiving a selection of one template from the GUI; and
generating the personalized recipient message using the selected template and the user-supplied content.

16. The method of claim 12, further comprising receiving time information associated with a time of delivery of the personalized recipient message from the user, and transmits the personalized recipient message at the scheduled time.

17. The method of claim 12, further comprising transmitting a hypertext link to the personalized recipient message to the recipient computing device, and the personalized recipient message stored in the memory, wherein the recipient computing device accesses the personalized recipient message via the hypertext link.

18. The method of claim 12, further comprising obtaining characteristic information about the customer from a social network site and displaying suggested content based upon the obtained characteristic information.

19. The method of claim 12, wherein the personalized recipient message is comprised entirely of user-supplied content.

20. Code implemented on a non-transitory, computer-readable medium, when executed by at least one processor, operable to perform at least the following:
receive in advance of delivery of the product or service to a recipient one or more instances of the user-supplied content from the user computing device, the user-supplied content associated with a product or service purchased by a customer;
generate a personalized recipient message using the user-supplied content; and
transmit the personalized recipient message to a recipient computing device of the recipient.
